(19) United States
(12) Patent Application Publication
(10) Pub. No.: US 2011/0047846 A1
(43) Pub. Date: Mar. 3, 2011

(54) MEDICAL INFO KEYCHAIN

(76) Inventor: Zora M. Hughes, Franklinville, NJ (US)

(21) Appl. No.: 12/868,290

(22) Filed: Aug. 25, 2010

Related U.S. Application Data
(60) Provisional application No. 61/236,595, filed on Aug. 25, 2009.

(51) Int. Cl. G09F 3/08

(52) U.S. Cl. 40/673

(57) ABSTRACT

A medical information key chain for use in emergency situations with a simple and concise means of quickly identifying the person and emergency medical information, includes a casing, key ring, and an information tag. The key ring would attach the tag to the user's keys. The tag could be manufactured from a variety of materials including but not limited to plastic, stainless steel, brass, pewter, silver, gold and platinum. The medical information key chain would be custom engraved by the wearer with vital identification and emergency medical information. This information would include the wearer's name, the doctor's name, address and telephone number, as well as a list of medications. The medical information key chain may also be engraved with other pertinent medical information such as the wearer's blood type, allergies to medication and recent surgical procedures.

### CONTINUITY DATA

This is a non-provisional patent application claiming priority to U.S. provisional patent application No. 61/236,595, filed on Aug. 25, 2009.

### FIELD OF THE INVENTION

The present invention relates to personal identification products and, more particularly, to a medical information key chain that provides identification and emergency medical information.

### BACKGROUND OF THE INVENTION

Everyday, thousands of people across the country are reported missing. In fact, according to statistics compiled by the Federal Bureau of Investigation's National Crime Information Center (NCIC), there were 840,279 missing person entries (adults and juveniles) in the year 2006. While the vast majority of missing persons cases are resolved within hours of a person's disappearance, there are many tragic incidents in which the person is never found, or is found dead. Sadly, many individuals reported missing each year are actually not missing, but because of injury or illness are unable to convey their identity to authorities. This can occur when one leaves home without first grabbing some form of identification, be it a driver's license or even a library card.

For example, an exercise enthusiast who lives alone might go out to take a brisk evening jog. During her run, she might suffer a heart attack or be struck by a car, leaving her unconscious, injured or dead. If the jogger is without identification, it may take days for authorities to contact her immediate family. This time period is not only a nightmare for family members searching for their missing loved one, it can also be deadly for the person, whose medical background will be unknown to medical staff. Important medical information which could save the person's life might go unrecognized if the person is without proper identification. Accordingly, there is a need for an apparatus that solve these problems.

The present invention solves these problems by providing a medical information key chain that is convenient and easy to use, lightweight yet durable in design, and versatile in its applications. It is designed to provide law enforcement officials and medical personnel with a simple means of quickly identifying a lost, sick or injured person, caring properly for that person, and contacting that person's family.

U.S. Patent Application 2008/0059236 submitted by Cartier et al. and published on Mar. 6, 2008 is for an emergency medical information device stored on a portable data storage device. The emergency medical information is automatically displayed on a computer when the device is mated to the computer. Cartier et al. differ from the present invention in that the present invention does not require to be mated with a computer in order to access the user's identification and medical information.

U.S. Pat. No. 5,012,229 issued to Lennon et al. on Apr. 30, 1991 is for a wearable personal/medical information device that includes a data display with an associated legend display. Lennon et al. differs from the present invention in that Lennon et al. employs read only memory and other technological means to store information, whereas the present invention does not require electronic means to accomplish its objectives.

U.S. Patent Application 2009/0295569 submitted by Corwin et al. and published on Dec. 3, 2009 is for a universal personal emergency medical information retrieval system. Corwin et al. differs from the present invention in that Corwin et al. stores a user's medical information onto a non-rewriteable radio frequency identification (RFID) tag using an RFID writer, the tag then being affixed to a user's driver's license, cell phone, etc. The present invention, on the other hand, requires no technological equipment in order to access the user's information.

U.S. Patent Application 2006/0042139 submitted by Mendes and published on Mar. 2, 2006 is for an athletic medical bracelet that contains the wearer's medical information. Mendes differs from the present invention in that Mendes employs a bracelet with electronic options designed for athletic use to communicate medical information, whereas the present invention employs a keychain designed for every day usage to convey emergency and medical information.

### SUMMARY OF THE PRESENT INVENTION

The present invention is a medical information key chain that is convenient and easy to use. It is designed to provide law enforcement officials and medical personnel with a simple means of quickly establishing the identity and medical information of a lost, sick or injured person, caring properly for that person, and contacting that person's family.

An especially unique aspect of the present invention is its “low tech” design. The marketplace abounds with devices that store a person's medical information on a portable device within a computer chip or other means of storage, yet these portable devices, though capable of storing large amounts of information, may not be able to be decoded in a life or death emergency situation. The present invention, however, allows a user to put pertinent information relating to personal identification and medical needs on a keychain attachment, the information printed in normal language rather than coded into a computer-readable device. The present invention is designed to be read immediately and on-the-spot by human beings such as police officers, emergency medical technicians (EMTs), etc.

The placement of the present invention on a keychain is also inspired. Many portable emergency information devices are in the form of bracelets or identification cards, yet a user may not remember to put on the bracelet or carry the identification card when he or she leaves home. And even if the user did have the identification card in his or her wallet, a police officer or EMT may not be able to locate it in an emergency. A keychain however, in comparison, is open to full view. In addition, whenever a person goes out of his or her home, the person invariably takes his or her keys in order to lock and unlock a house and operate an automobile. Therefore a keychain is a superb choice for placement of emergency identification and medical information.

Lastly, the layout of the information fields on the keychain is designed for maximum usefulness in an emergency situation. There are two information tags on the keychain, a first information tag and a second information tag. The first information tag is intended to hold all of the user's personal identification information that would be pertinent in an emergency situation. There is also room on the first information tag to list any major medical conditions that a responding police officer or EMT should be immediately informed of The second information tag is intended to list the user's current medications and their daily dosage amounts, and the name and contact information of the user's doctor.

In short, the present invention employs a practical approach to quickly and efficiently conveying, in time sensitive and stressful situations, crucial information about a user's identification and medical needs.

### BRIEF DESCRIPTION OF THE DRAWINGS

FIG. 1 shows the first side (10) of the present invention.

FIG. 2 shows the second side (15) of the present invention.

### DETAILED DESCRIPTION OF THE PRESENT INVENTION

The apparatus of the present invention is a medical information key chain used to provide identification information (45) and medication information (48) about the user of the present invention. In the preferred embodiment of the present invention, the first side (10) of the present invention displays a first information tag (30) with the user's identification information (45), and the second side (15) displays a second information tag (35) with the user's medication information (48). Both the first information tag (30) and second information tag (35) are placed into a casing (25) through a slot (40) located at the summit of the present invention. The slot (40) enables the user to easily insert updated information tags (30 and 35) into the casing (25). The casing (25) attaches to a key ring (20), which in turn can attach to the user's one or more keys (11). The preferred embodiment of the present invention envisions the casing (25) as manufactured in plastic, and the information tags (30 and 35) as paper on which the user's identification information (45) and medication information (48) is printed.

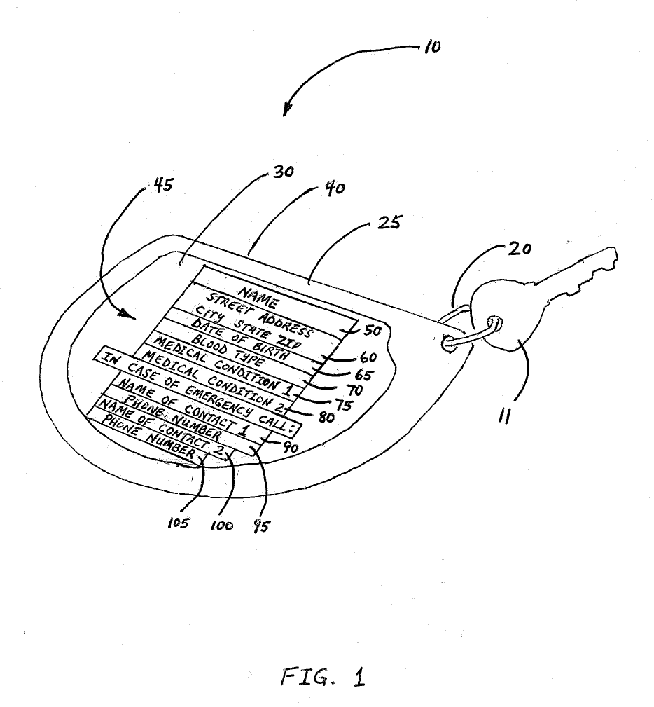

FIG. 1 shows the first side (10) of the present invention, displaying the first information tag (30) inside the casing (25) of the present invention, and the casing (25) connected to one or more of the user's keys (11) via a conventional key ring (20). The first information tag (30) is inserted into the casing (25) through a slot (40) at the summit of the casing (25). The preferred embodiment of the first information tag (30) is envisioned as listing the user's identification information (45) in specific fields, specifically a name field (50), a home address field (60), a date of birth field (65), a blood type field (70), a first medical condition field (75), a second medical condition field (80), a first emergency contact name field (90), a first emergency contact phone field (95), a second emergency contact name field (100), and a second emergency contact phone field (105). Other embodiments of the first information tag (30) can also include fields for allergies, insurance information, or any other information crucial in a medical emergency.

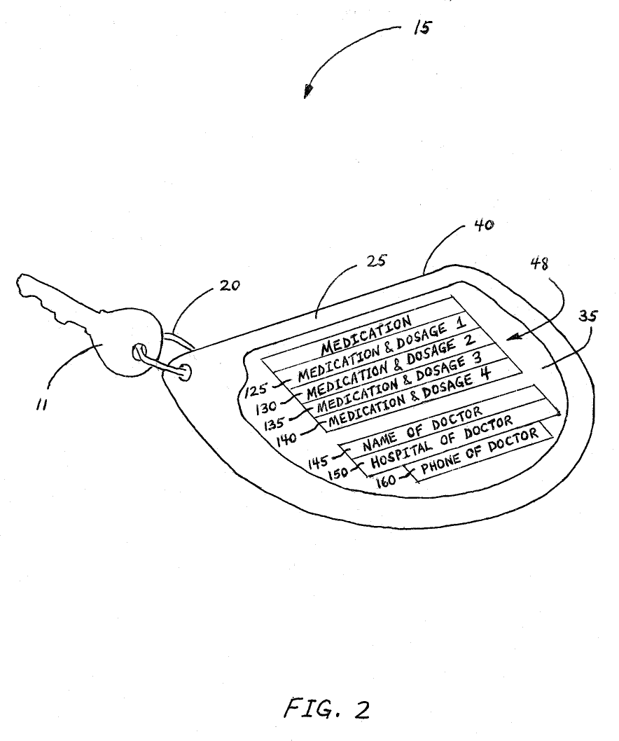

FIG. 2 shows the second side (15) of the present invention, displaying the second information tag (35) inside the casing (25) of the present invention, and the casing (25) connected to one or more of the user's keys (11) via a conventional key ring (20). The second information tag (35) is inserted into the casing (25) through a slot (40) at the summit of the casing (25). The preferred embodiment of the second information tag (35) is envisioned as listing the user's medication information (48) in specific fields, specifically in a first medication and dosage field (125), a second medication and dosage field (130), a third medication and dosage field (135), and a fourth medication and dosage field (140), along with a name of doctor field (145), a hospital of doctor field (150), and a phone of doctor field (160). Other embodiments of the second information tag (35) can include fields for additional medications, additional doctors and their contact information, or any other information crucial in a medical emergency.

Continuing with the example given above, the jogger who lives alone goes out to take a brisk evening jog and suffers a heart attack. Although unconscious and not carrying a wallet, the jogger has in her pocket her house keys with the present invention attached to her key ring (20) and keys (11). A spectator calls 9-1-1, EMTs arrive and place the jogger in an ambulance, and as part of their procedures they pat down the unconscious jogger to find medical information. The EMTs hear the keys jingling in one of the user's pockets, and upon removing them discover the present invention. It immediately informs them that the jogger wears a pacemaker and takes heart medication, which signals the EMTs to treat the jogger for a heart attack. Upon arrival at the hospital, the EMTs turn over the present invention to the hospital staff, who use it to notify the contact personnel of the jogger's condition. The hospital staff also learn at a glance what medications the jogger is currently taking, then call the jogger's physician who informs the hospital of the patient's medical history. In this manner, important medical information is quickly given to the hospital staff so they can best respond to the jogger's condition.

In alternative embodiments, the apparatus may feature a variety of sizes and shapes and may be worn with a chain or the like around the neck or wrist. In addition, ornamental designs may be featured or adapted to be used with jewelry accessories around the neck or wrist. Furthermore, it will be appreciated that many modifications and changes may be made by those skilled in the art without departing from the spirit of the invention. It is intended, therefore, by the appended claims to cover all such modifications and changes as fall within the true spirit and scope of the invention.

In summary, the present invention is a medical information key chain for a user, comprising a casing (25) that attaches to a key ring (20); a first information tag (30) with the user's identification information (45), in communication with said casing (25); and a second information tag (35) with the user's medication information (48), in communication with said casing (25).

In addition, the identification information (45) comprises a name field (50), a home address field (60), a date of birth field (65), a blood type field (70), a first medical condition field (75), a second medical condition field (80), a first emergency contact name field (90), a first emergency contact phone field (95), a second emergency contact name field (100), and a second emergency contact phone field (105). The medication information (48) comprises a first medication and dosage field (125), a second medication and dosage field (130), a third medication and dosage field (135), a fourth medication and dosage field (140), a name of doctor field (145), a hospital of doctor field (150), and a phone of doctor field (160).

Furthermore, the first information tag (30) is in communication with a first side of said casing (25), the second information tag (35) is in communication with a second side of said casing (25).

Having illustrated the present invention, it should be understood that various adjustments and versions might be implemented without venturing away from the essence of the present invention. The present invention is not limited to the embodiments described above, and should be interpreted as any and all embodiments within the scope of the following claims.

1. A medical information key chain for a user, comprising
a casing that attaches to a key ring;
a first information tag with the user's identification information, in communication with said casing; and
a second information tag with the user's medication information, in communication with said casing.

2. The medical information key chain of claim 1, wherein said identification information comprises:
a name field,
a home address field,
a date of birth field,
a blood type field,
a first medical condition field,
a second medical condition field,
a first emergency contact name field,
a first emergency contact phone field,
a second emergency contact name field, and
a second emergency contact phone field.

3. The medical information key chain of claim 1, wherein said medication information comprises
a first medication and dosage field,
a second medication and dosage field,
a third medication and dosage field,
a fourth medication and dosage field,
a name of doctor field,
a hospital of doctor field, and
a phone of doctor field.

4. The medical information key chain of claim 2, wherein said medication information comprises
a first medication and dosage field,
a second medication and dosage field,
a third medication and dosage field,
a fourth medication and dosage field,
a name of doctor field,
a hospital of doctor field, and
a phone of doctor field.

5. The medical information key chain of claim 1, wherein said first information tag is in communication with a first side of said casing.

6. The medical information key chain of claim 1, wherein said second information tag is in communication with a second side of said casing.

7. The medical information key chain of claim 5, wherein said second information tag is in communication with a second side of said casing.

8. The medical information key chain of claim 5, wherein said identification information comprises:
a name field,
a home address field,
a date of birth field,
a blood type field,
a first medical condition field,
a second medical condition field,
a first emergency contact name field,
a first emergency contact phone field,
a second emergency contact name field, and
a second emergency contact phone field.

9. The medical information key chain of claim 6, wherein said identification information comprises:
a name field,
a home address field,
a date of birth field,
a blood type field,
a first medical condition field,
a second medical condition field,
a first emergency contact name field,
a first emergency contact phone field,
a second emergency contact name field, and
a second emergency contact phone field.

10. The medical information key chain of claim 7, wherein said identification information comprises:
a name field,
a home address field,
a date of birth field,
a blood type field,
a first medical condition field,
a second medical condition field,
a first emergency contact name field,
a first emergency contact phone field,
a second emergency contact name field, and
a second emergency contact phone field.

11. The medical information key chain of claim 5, wherein said medication information comprises
a first medication and dosage field,
a second medication and dosage field,
a third medication and dosage field,
a fourth medication and dosage field,
a name of doctor field,
a hospital of doctor field, and
a phone of doctor field.

12. The medical information key chain of claim 6, wherein said medication information comprises
a first medication and dosage field,
a second medication and dosage field,
a third medication and dosage field,
a fourth medication and dosage field,
a name of doctor field,
a hospital of doctor field, and
a phone of doctor field.

13. The medical information key chain of claim 7, wherein said medication information comprises
a first medication and dosage field,
a second medication and dosage field,
a third medication and dosage field,
a fourth medication and dosage field,
a name of doctor field,
a hospital of doctor field, and
a phone of doctor field.
